(19) United States
(12) Patent Application Publication
(10) Pub. No.: US 2006/0069790 A1
(43) Pub. Date: Mar. 30, 2006

(54) Content presentation adaptation

(76) Inventor: Surender Surana, Vantaa (FI)

Correspondence Address: PERMAN & GREEN, 425 POST ROAD, FAIRFIELD, CT, 06824, US

(21) Appl. No.: 10/954,921

(22) Filed: Sep. 30, 2004

(51) Int. Cl. G06F 15/16

(52) U.S. Cl. 709/230

(57) ABSTRACT

The present invention relates to a method of arranging content presentation for a data transmission system. A received object to be transmitted to the recipient terminal is associated with presentation description information or with a reference to presentation description information defined in the control point and transmitted to the recipient terminal. The recipient terminal may then present object data in accordance with the presentation description information.

### FIELD OF THE INVENTION

The present invention relates to content presentation adaptation.

### BACKGROUND OF THE INVENTION

WAP (Wireless Application Protocol) is a widely used protocol for delivering Internet content to wireless devices. A WAP compliant mobile system employs WAP gateways, which perform protocol conversion between the WAP protocol stack used in the mobile network and the TCP/IP and HTTP stack used in a WWW (World Wide Web) system. These devices are also sometimes referred to as WAP proxy servers. Also content encoders and decoders may be utilized in WAP gateways, particularly to convert conventional HTML (Hypertext Markup Language) pages into WML (Wireless Mark-up Language) suitable for transmission over the radio interface to wireless terminals.

In conventional HTML pages, the page layout, for instance colours and fonts, has to be determined within the page description, i.e. in each HTML file. However, cascading style sheets (CSS) have been developed to control how the content is presented on the screen in the browser. Cascading style sheets separate the presentation (for instance spacing, colors, and fonts) from the content (for instance document structure, text, and images). Changes to the presentation can be made in the style sheet and the changes are automatically reflected throughout the whole document. Cascading style sheets make it easy and cost-efficient to display the same content on a wide variety of devices, each with their own display formats and capabilities.

CSS support has been developed for mobile systems, too. XHTML together with cascading style sheets enable application developers to more easily provide content to both WAP and Web domains by using similar markup languages and developer tools. There are mobile stations which can use CSS files and also WAP gateways that can deliver CSS files to mobile terminals via the WAP protocol. However, a content creator or another party forming the CSS sheets for a HTML/WML page is not always aware of the properties of the recipients, and thus the delivered CSS sheets are not always appropriate.

### BRIEF DESCRIPTION OF THE INVENTION

There is now provided an improved solution for defining content presentation for a recipient terminal. This improvement is achieved by methods, a system, a communications device, a module, a mobile terminal, a computer program, and a computer program product, which are characterized by what is stated in the independent claims. Some embodiments of the invention are disclosed in the dependent claims.

According to an aspect of the present invention, a presentation description format for a received object or for data derived from the object, to be transmitted to a recipient terminal, is arranged by an intermediary control point. The received object or data derived from the object is associated with presentation description information according to a presentation description format or with a reference to presentation description information according to a presentation description format and transmitted to the recipient terminal. The recipient terminal may then present the object or data derived from the object in accordance with the presentation description information. The term object as herein used generally refers to any data structure comprising information that may be presented in a recipient terminal, for instance a file comprising HTML data. The term presentation description information refers to any kind of information defining at least some aspect of the appearance of the object, for instance a style sheet for a HTML or WML page. The association of the object with the presentation description information is to be understood broadly: it may mean that the presentation description information is actually included in the object or that the presentation description information is included for transmission in a same protocol data structure as the object, for instance.

An advantage of the method and arrangement of the invention is that a more appropriate presentation format and thus a style for content displayable in the recipient terminal may be defined. This definition is performed by an intermediary entity and thus there is no need to specify presentation formats for different recipients or end systems in the device originating the content. Further, a particular style may thus be arranged for an XML-based file downloaded from and/or formed by a source not supporting style sheets, for instance. When applied to mobile systems, it is possible to consider the specific aspects of mobile systems and the interests of the mobile operators more effectively.

In one embodiment, an operator or service provider specific style can be arranged to the mobile terminal by operator or service provider specific presentation description information (or references to such information) selected by the control point. The control point may be part of the network operator's or service provider's system. According to an embodiment, original presentation description information or original reference to presentation description information is removed from the received object. Thus original presentation description file may be replaced by another one, for instance by one including the mobile service provider's logo and colour scheme.

In another embodiment, at least one property associated with the recipient terminal is checked by the control point. The suitable presentation description format is selected on the basis of the property of the recipient terminal. This embodiment enables selection of suitable style, taking into account the properties, for instance screen properties of the terminal. For instance, terminal model specific style sheets may be utilized.

### BRIEF DESCRIPTION OF THE DRAWINGS

In the following, the invention will be described in greater detail by means of some embodiments with reference to the accompanying drawings, in which

FIG. 1 illustrates elements of a mobile system according to an embodiment of the invention;

FIGS. 2a and 2b illustrate a method according to an embodiment of the invention; and

FIGS. 3a and 3b illustrate methods according to some embodiments of the invention.

### DETAILED DESCRIPTION OF THE INVENTION

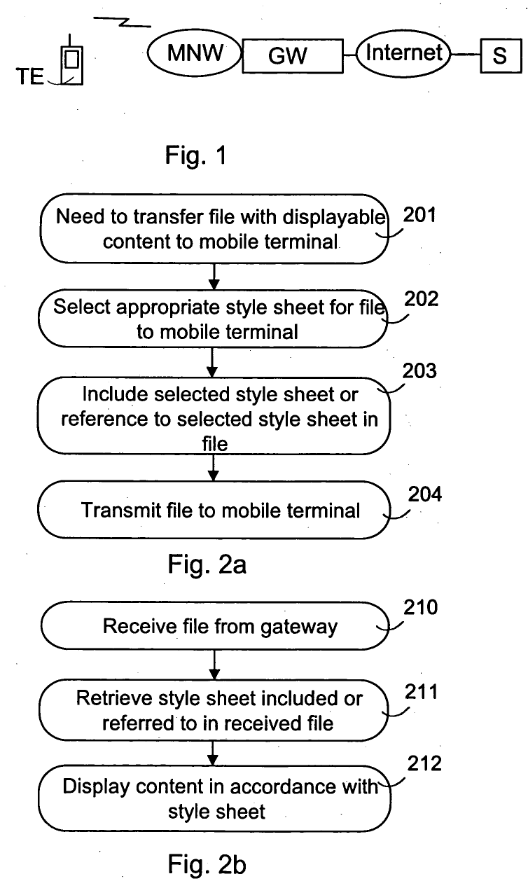

FIG. 1 illustrates a networked system, in which content may be transferred from a server S to a terminal TE via a mobile network MNW and an intermediate entity, in the example of FIG. 1 via a WAP gateway GW. The mobile network MNW may be an already known or a future mobile network, such as a GSM network, a GSM/GPRS network, a 3G network [for instance a network according to the 3GPP (Third Generation Partnership Project) system], a wireless local area network (WLAN) or a network combining some of these network functions. The assumption in the following embodiments is that, from the point of view of data downloading, the terminal TE may serve as the client device and the server S as the server. However, it is to be noted that client-server relationships may exist between the terminal TE and the gateway GW, and between the GW and the server S. A network server or a PC typically acts as a server S. A terminal TE is typically a mobile phone, a PC, a laptop computer or a PDA device.

In one scenario, the server S is a HTTP (hypertext transfer protocol) server and communication between the gateway GW and the server S is arranged by the HTTP and TCP/IP (transport control protocol/internet protocol). The WAP (Wireless Application Protocol) is utilized for transferring the data from the WAP gateway GW to the terminal TE. The WSP layer (Wireless Session Protocol) of the WAP protocol suite is then used to provide transport service for the downloading service layer in the client device TE and server S. In WAP version 2.0, an HTTP (Hypertext Transfer Protocol) can also be used. In this case, the system comprises at least one WAP gateway and optionally one or more WAP proxy servers. The WAP supports many lower-level transfer techniques, such as circuit or packet-switched data transfer or SMS-based transfer in accordance with the properties of the underlying mobile network MNW. It is to be noted that, instead of the example in FIG. 1, the WAP gateway GW may be part of the mobile network MNW, even implemented in a device performing some other tasks in the mobile network MNW.

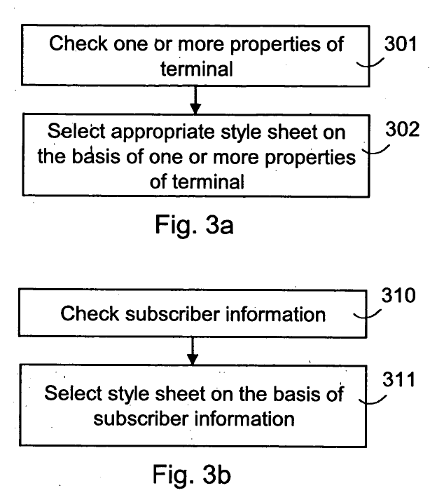

A data processing device functioning as the intermediary control point, in the present embodiment as the WAP gateway GW, comprises memory, I/O means for arranging data transmission and a processing unit comprising one or more processors. Computer program codes executed in the processing unit may be used for causing the data processing device to implement means for controlling the adaptation of the content presentation for mobile terminals (TE) and more precisely the selection of the suitable presentation description format for the recipient terminal. Some embodiments of these functions are illustrated later in association with FIGS. 2a, 2b, 3a, and 3b. A chip unit or some other kind of module for controlling the data processing device may in one embodiment cause the device to perform the inventive functions. The module may form part of the device and could be removable, i.e. it is insertable into another unit or device. Computer program codes can be received via a network and/or stored in memory means, for instance on a disk, a CD-ROM disk or other external memory means, from where they can be loaded into the memory of the data processing device. Hardware solutions or a combination of hardware and software solutions may also be used to implement the inventive functions. It is to be noted that the presentation description formats for the recipient terminal may be stored in an internal memory or an external memory of the data processing device.

FIG. 2a illustrates a method according to an embodiment of the invention the steps of FIG. 2a may be implemented in an intermediary control point, in the present embodiment in the WAP gateway GW. The procedure of FIG. 2a may be implemented in connection with the protocol conversion for a received file in the WAP gateway GW, for instance. It is to be noted that the gateway GW, in which the present functionality is applicable, may instead of a WAP gateway be a proxy gateway, a mobility gateway, a browsing gateway or another intermediate gateway not performing protocol conversion to WAP protocols and used for transmitting Internet content to the mobile network MNW. Alternatively, the present functionality may be applied in a mobile network (MNW) operator control point not comprising any gateway functionality, for instance by additional functionality in a node connecting the packet service system of the mobile network MNW to the Internet. Such node in the GSM/GPRS system and 3GPP system could be the GGSN (gateway GPRS support node) or a PEP (Policy Enforcement Point). In an alternative embodiment the present functionality may be applied in a control point outside the mobile network MNW. For instance, such intermediary control point could reside in the Internet, even within the server S.

In step 201 there is a need to transfer a file including some displayable content to the mobile terminal TE. In one scenario, a file is received from a HTTP server S and the content of the file needs to be transmitted to the terminal TE. Therefore, the WAP gateway GW may also perform encoding functions before or after step 201 (but before step 204) to adapt the content from the original HTML format to the WML or XHTML format better suitable for transmission over the radio interface. In another embodiment, the intermediate entity does not change the file format as such but arranges the transmission of the (HTML, XHTML or WML) file using the WAP protocol layers used between the GW and the terminal TE.

In step 202 an appropriate style sheet is selected for the mobile terminal TE. There are multiple embodiments for this step, which are illustrated in more detail later. The GW may be arranged to select a pre-determined style sheet or the GW may be provided with pre-determined rules on the basis of which the style sheet will be selected. Additional information from the file and/or other network elements may be required for this selection step.

The selected style sheet or reference to the selected style sheet is included 203 in the file, or in another embodiment in a data structure carrying the file. Thus, it might not always be necessary to transfer the style sheet to the mobile terminal TE if the style sheet already exists in the terminal TE or if it is desired that the terminal TE will retrieve the referred style sheet from a storage position. Step 203 may involve addition of the style sheet or reference to the style sheet, and/or at least partial replacement of an existing, original style sheet, with the new selected style sheet. For instance, if included in the file comprising the displayable content, the style sheet information may be defined by adding one or more <style> tags, or directly adding this information in a relevant element of the file. Further, if an original style sheet or part thereof needs to be removed in step 203 or already earlier, the GW may be arranged to search for a particular type of file (for instance a .css file) from the received data. The GW may also be arranged to parse a received file with displayable content in order to find a particular tag, and/or more detailed style sheet information. If this kind of file or an information element within a file with a displayable content is found, such a file or information element is removed before step 204. Thus, the GW may be provided with one or more removal criteria determining the parts of received data to be removed. The file may be transmitted 204 to the mobile terminal. It is to be noted that the file may also be internally transmitted for the recipient terminal (TE). In the present embodiment, at least part of the WAP protocol suite may be used.

FIG. 2b illustrates functions of an embodiment suitable for implementation in a client device, in the present embodiment in the mobile terminal TE supporting WAP and functioning as the WAP client. In step 210 a file with displayable content is received from the WAP gateway GW. The style sheet included in the file by a control point, such as the WAP gateway GW, is retrieved 211 from the file, or alternatively, the style sheet referred to in the file is retrieved from an internal or external storage position. This step is typically carried out when the file needs to be displayed in the device (typically immediately after reception). In step 212 the content in the file is presented in accordance with the style sheet.

FIG. 3a illustrates features of an embodiment relating to the selection of the style sheet for the mobile terminal TE. The features of FIG. 3a can thus be implemented as part of the method illustrated in FIG. 2a. In step 301 at least one property associated with the terminal TE is checked. There are various properties which may be used in the present embodiment. As examples, the size of the display or support of colours could be used. In one embodiment, the GW is configured with instructions determining the one or more properties which should be checked. The properties may be checked in step 301 from device information maintained by GW, from a network element of the mobile network MNW maintaining a terminal information database, or by requesting the property information from the TE.

A suitable presentation description format, in the present embodiment the CSS, is selected 302 on the basis of one or more properties of the recipient terminal TE. The GW may be provided with instructions, for instance a look-up table, defining which style sheet is to be selected for which property attribute. There could also be some default style sheet, which is selected if no specific style sheet is associated with the property obtained in step 301.

There could be further rules taking also the nature of the content to be transferred to the mobile terminal. TE into account. Thus the above steps could also include the checking of one or more properties of the file to be transmitted to the mobile terminal TE, and selection of the style sheet taking also the properties of the file into account. This embodiment could also be used independently of the above terminal specific style sheet selection. Thus the style sheet may be selected in step 202 on the basis of one or more properties of the file to be transmitted.

According to an embodiment illustrated in FIG. 3b, subscriber information associated with the recipient terminal TE is checked 310 when there is a need to select the style sheet for the file to the terminal TE (step 202 in FIG. 2a). This subscriber or user information may be checked by defining a recipient identifier on the basis of the message to be transmitted to the terminal TE. The style sheet is then selected 311 using the subscriber information. A connection may be established to a home location register (HLR) of the mobile network MNW for determining the correct style sheet and/or for retrieving subscriber information. Subscriber or subscriber group specific style sheets may thus be selected. By this embodiment, it is possible to differentiate appearance of the Internet content or WAP pages between different subscribers or users. For instance, private mobile service users may be provided with different style sheets than corporate users. In a further embodiment, the subscriber information in the home location register may specify whether it is allowed to change the style sheet and the style sheet may be included in the file only if this is allowed in the subscriber information.

In an embodiment, operator specific presentation description information or references to such operator or service provider specific information are stored in the intermediary control point. The WAP gateways GW are typically operator specific and thus the operator can easily adapt the presentation format to have the same look regardless of the browsed content and the location from which the content is retrieved. For instance, a certain operator logo could be defined in the style sheet in a background frame and an operator specific colour could be determined as the background colour. Service provider is in many networks an entity separate from the actual network operator, and the latter may be a transparent entity from the user's point of view. Therefore, the WAP gateway GW may be configured to apply the style sheet of the service provider providing the WAP browsing service or another service for the mobile terminal TE.

The operators and the service providers can then effectively use the style sheets for advertising and brand maintenance. The application of the style sheet replacement is not limited to style sheets of the mobile services providers but basically any style sheet could be arranged by the WAP gateway GW or another intermediate entity attending to transmission of content to a mobile terminal TE. These control points functioning as intermediate entities may then be provided with control of the appearance of information in the mobile terminal.

In the following, an example scenario is illustrated. An end user is surfing the Internet with his mobile terminal. A GET request for a particular Web resource (including a URL of the resource) is passed via the GW to the Web server, for instance the server S. The server S responds with the requested content and a CSS associated with the content. The WAP gateway GW is configured to remove the original CSS and add a selected CSS of a promotional company. When this content will be presented on the mobile terminal's TE display, promotional information on the CSS is also displayed.

In one embodiment, the style sheets are associated with different priority classes. The control point, for instance the GW, may be arranged to select a style sheet having the highest priority. These priority classes may be adapted according to recipient terminal properties, content properties and/or some other criteria. Thus the prioritization can be applied in at least some of the above-illustrated embodiments. This embodiment gives more flexibility on the selection amongst the available style sheets and is especially useful when there are multiple style sheets that could be used in the receiving terminal. These prioritizations may change over time, for instance.

In one embodiment, the WAP CSS is utilized. For more details on the specified WAP CSS, reference is made to WAP Forum (currently under OMA (Open Mobile Alliance) WAP specification “WAP CSS Specification, Version 26-Oct.-2001”, 64 pages. Instead of CSS, other presentation description information formats may be applied. As an example, XSL (XML style sheet) based formats may be applied in the control point.

In an embodiment, instead of the above illustrated gateway GW, the intermediary control point is implemented in the recipient terminal (TE) and/or in a module for the recipient terminal TE. This module could be a subscriber identity module (SIM) in accordance with the GSM standard or the 3GPP standard. The module may be removable and comprise also other network operator or service provider specific data. The module typically comprises I/O means for data transfer with the recipient terminal TE, memory, and a processor controlled by a program code store in the memory. When a file such as a HTML file is received, the file is transmitted to the module. For instance, files for a Web or a WAP browser in the terminal TE could be defined in the recipient terminal TE as files to be submitted to the module for presentation adaptation. The processor of the module may perform the tasks illustrated above in connection with FIG. 2a. For instance, the module may at least partially remove original style sheet and add a new style sheet predetermined (and/or stored) in the module. The module may then send the modified file to an entity further processing the file. This entity could be an application process in the processor unit of the recipient terminal TE. Further, at least part of the above illustrated other embodiments could also be applied by the module.

The advantage especially for operator owned subscriber identity modules is that operator specific appearance could be arranged for files with displayable content even if the file was not transmitted via the operator's network or gateway (GW). For instance, if the user is roaming, the home operator's logo could be displayed on a browsed page although the page was loaded via a roamed network of another operator. In an alternative embodiment the module follows the files received in the recipient terminal TE. For instance, the module may check the files for the Web or the WAP browser and performs the presentation adaptation for the files before presentation by the browser. The adaptation may even be performed by a processor of the recipient terminal TE on the basis of a request and a style sheet from the module.

It should be appreciated that the above-illustrated embodiments may be combined in various ways. It will be obvious to a person skilled in the art that, as the technology advances, the inventive concept can be implemented in various ways. The invention and its embodiments are not limited to the examples described above but may vary within the scope of the claims. Different features may thus be omitted, modified or replaced by equivalents.

1. A method of defining content presentation for a communications system, the method comprising:
receiving an object to be transmitted to a recipient terminal in an intermediary control point,
associating, in the intermediary control point, the object or data derived from the object with presentation description information or with a reference to presentation description information, and
transmitting the object or data derived from the object associated with the presentation description information or associated with the reference to presentation description information.

2. The method according to claim 1, the method further comprising:
presenting, in the recipient terminal, at least some data in the object or data derived from the object in accordance with the received presentation description information.

3. The method according to claim 1, wherein the control point selects the presentation description format on the basis of predetermined selection instructions.

4. The method according to claim 3, wherein at least one property associated with the recipient terminal is checked by the control point, and
the presentation description format is selected on the basis of the property of the recipient terminal.

5. The method according to claim 1, wherein the object or data derived from the object is modified to include the presentation description information or the reference to the presentation description information.

6. The method according to claim 5, wherein original presentation description information or an original reference to presentation description information is removed from the received object or data derived from the object.

7. The method according to claim 1, wherein a network operator specific or a service provider specific presentation description file or a reference to such presentation description file is stored in the system for the control point and associated with the object or data derived from the object.

8. The method according to claim 1, wherein the presentation description information is a CSS (Cascading Style Sheet) file.

9. A data transmission system comprising an intermediary control point controlling data transmission to a recipient terminal, wherein the system is configured to receive an object to be transmitted to a recipient terminal in control point,
the control point is configured to define for the object or data derived from the object presentation description information or a reference to presentation description information,
the system is configured to transmit the object or data derived from the object associated with the presentation description information or associated with the reference to the presentation description information.

10. A data transmission system according to claim 9, wherein the recipient terminal is configured to present at least part of the object or data derived from the object according to the presentation description information.

11. A data transmission system according to claim 9, wherein the system is a mobile system configured to transmit data to a mobile recipient terminal.

12. A communications device for intermediating data transmission for a recipient terminal, the communications device comprising:
means for receiving an object to be transmitted to a recipient terminal,
means for associating the object or data derived from the object with presentation description information or with a reference to presentation description information, and
means for transmitting the object or data derived from the object for the recipient terminal.

13. A communications device according to claim 12, wherein the control point is configured to select the presentation description format on the basis of predetermined selection instructions.

14. A communications device according to claim 13, wherein the communications device is configured to check at least one property associated with the recipient terminal, and
the communications device is configured to select the presentation description format on the basis of the property of the recipient terminal.

15. A communications device according to claim 12, wherein the communications device is configured to modify the object or data derived from the object to include the presentation description information or the reference to the presentation description information.

16. A communications device according to claim 15, wherein the communications device is configured to remove original presentation description information or an original reference to presentation description information from the received object or data derived from the object.

17. A communications device according to claim 12, wherein the communications device is configured to associate the object or data derived from the object with a network operator or a service provider specific presentation description file or a reference to such network operator or a service provider specific presentation description information.

18. A communications device according to claim 12, wherein the presentation description information is a CSS (Cascading Style Sheet) file.

19. A communications device according to claim 12, wherein the communications device is a WAP gateway.

20. A method for defining appearance of content in a recipient terminal, the method comprising:
associating, by an intermediary control point, an object to be transmitted to the recipient terminal with a network operator specific or a service provider specific presentation description or with a reference to such presentation description defining the appearance of an object comprising displayable content.

21. A module for a mobile terminal, the module comprising:
means for receiving an object,
means for associating the object with presentation description information or with a reference to presentation description information, and
means for sending the presentation description information or the reference to presentation description information to an entity of the mobile terminal for arranging presentation of at least some data in the object in accordance with the presentation description information.

22. A mobile terminal comprising:
means for receiving an object,
means for associating the object with presentation description information or with a reference to presentation description information, and
means for presenting at least some data in the object in accordance with the presentation description information.

23. A computer program for controlling a data processing device, configured to intermediate data transmission for a recipient terminal, by executing the program code included in the computer software product in a processor of the data processing device, wherein the computer software product comprises
a program code portion for causing the data processing device to associate an object addressed to a recipient terminal with presentation description information or with a reference to presentation description information.

24. A computer program product for controlling a data processing device, configured to intermediate data transmission for a recipient terminal, by executing the program code included in the computer software product in a processor of the data processing device, wherein the computer software product comprises
a program code portion for causing the data processing device to associate an object addressed to a recipient terminal with presentation description information or with a reference to presentation description information.
